(19) United States
(12) Patent Application Publication
(10) Pub. No.: US 2008/0142560 A1
(43) Pub. Date: Jun. 19, 2008

(54) GROCERY BAG BAR AND HOLDING SYSTEM

(76) Inventor: Stephen T. Lim, Farmington Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/612,747

(22) Filed: Dec. 19, 2006

(51) Int. Cl. B60R 7/08; B60R 7/00

(52) U.S. Cl. 224/543; 211/12

(57) ABSTRACT

This invention provides a retractable, pivotable, slidable, and removable horizontal bar device designed for securely holding in place conventional plastic grocery bags when such grocery bags, filled with groceries or other items, are being transported in a vehicle, maintaining the bags in an upright, suspended position on or above the floor of the interior trunk or cargo compartment of an automobile. A pair of the grocery bag bars and holding systems may be used to further provide a detachable and removable cross support bar.

### FIELD OF THE INVENTION

This invention relates generally to the field of bag holding devices, and more particularly, to a retractable, pivotable, slidable, and removable horizontal bar device designed for securely holding in place conventional plastic grocery bags or the like when such grocery bags, filled with groceries or other items, are being transported in a vehicle. The device maintains the bags in an upright, suspended position on or above the floor of the interior trunk or cargo compartment of an automobile.

### BACKGROUND OF THE INVENTION

The grocery bags now in general use in supermarkets are formed of a thin plastic material having a pair of upwardly extending handle loops on opposing sides of the bag. Once such bags are placed in an interior compartment of an automobile, such as a trunk or rear cargo space, the bags and their various contents, which have no lateral or suspension support, are subject to shifting and disorder, often resulting in spilled contents which have escaped their bag. Thus, a need exists for a grocery bag holding system for loading, storing, securing, and unloading such grocery bags in an interior cargo compartment of an automobile.

A variety of grocery bag holders, and like devices have been described previously and are known in the related art. None of the grocery bag holders, however, are designed to solve the particular problem addressed by the present invention and none are capable of being modified to do so. For example, U.S. Pat. No. 5,287,971, issued to Dorman on Feb. 22, 1994, and U.S. Pat. No. 5,427,288, issued to Trubee on Jun. 27, 1995, each disclose grocery bag holders. Both Dorman and Trubee disclose the use of clamping hooks upon which to place grocery bag handles and thus secure the bags. Neither Dorman nor Trubee disclose a grocery bag bar holding system mounted in the rear interior quarter trim panel and including a retractable, pivotable, slidable, and removable bar device designed for securely holding in place conventional plastic grocery bags. Therefore, a need still exists for a simple, inexpensive, retractable, pivotable, slidable, and removable bar holding device that enables thin, plastic bags with handles to be anchored to a supporting structure in a vehicle to prevent the bags from shifting about and creating disorder.

### BRIEF SUMMARY OF THE INVENTION

In various exemplary embodiment, the present invention provides a grocery bag bar holding system for securely holding in place conventional plastic grocery bags or the like when such grocery bags, filled with groceries or other items, are being transported in a vehicle. The device maintains the bags in an upright, suspended position on or above the floor of the interior trunk or cargo compartment of an automobile.

In one exemplary embodiment, the present invention provides a bag holding system for securely holding in place filled bags equipped with handles in an upright, suspended position while being transported in an automobile, the bag holding system including a horizontal bar, which pivots out of a system casing located within an interior panel in a cargo area in the automobile, the horizontal bar mounted to a pivot arm within the system casing. The horizontal bar, once loaded with the bags, is rotated back on the pivot arm and returned to the system casing, thus securely holding the bags in a suspended manner. The bag holding system includes a raised lip, located on the top outer end of the horizontal bar, which prevents bag handles from sliding off of the horizontal bar.

The bag holding system includes a linear slide, comprising a pivot, which securely holds the pivot arm and the horizontal bar, a plurality of slide liners, and a linear track, upon which the linear slide is mounted and moves in a linear direction. The slide liners act as a cushion between the linear slide and the linear track, and allow for a smooth motion about the linear track. The linear slide and the linear track, upon which the linear slide is mounted, are located within the system casing. The pivot arm holding the horizontal bar has a receptacle for the pivot, and is mounted to the linear slide on the pivot, the linear slide moving about the linear track in a linear manner.

The bag holding system includes a release lever and a locking screw on the linear slide. The linear track includes a linear groove. The release lever operates to rotate the locking screw in a downward fashion into a secure position, holding the linear slide, pivot arm, and horizontal bar in place at a location along the linear track. The locking screw is accepted by the linear groove in the linear track. Optionally, the release lever is a three-position release lever and the locking screw position is in one of locked, unlocked, or unlocked-but-spring-loaded to return the release lever to the locked position. The pivot arm includes a quick release button such that the horizontal bar is detachable and removable from the pivot arm.

The bag holding system includes a handle, located on the horizontal bar and which slides along the horizontal bar; a handle grip, located on the handle; a raised lip, located on the top outer end of the handle, which prevents bag handles from sliding off of the handle; and a receptacle to a quick release button on the horizontal bar, wherein the quick release button, when located in the handle receptacle, acts to hold the handle in a predetermined location along the horizontal bar.

In another exemplary embodiment of the present invention, the bag holding system includes a second horizontal bar, which pivots out of a second system casing located within an interior panel in a cargo area in the automobile, the second horizontal bar mounted to a second pivot arm within the second system casing, wherein the second horizontal bar is mounted in an opposite interior panel in the cargo area in the automobile. The horizontal bar and second horizontal bar are joined together with a handle located on the horizontal bar and securely attached on to another, thus providing a cross support bar. The handle located on the horizontal bar includes a pair of friction locks, located on the top and bottom interior sides of the handle, the friction locks securely holding the second horizontal bar in place when the horizontal bar and second horizontal bar are joined together to create the cross support bar. The cross support bar, formed when the horizontal bar and second horizontal bar are joined together, is detachable and removable for use independent from the bag holding system, wherein the horizontal bar and the second horizontal bar are detachable from their respective pivot arms by depressing the quick release button on the horizontal bar and the second horizontal bar.

Advantageously, the bag holding system of the present invention overcomes many of the deficiencies known in the art pertaining to grocery bag holders. A user of the bag holding system can quickly load, secure, and unload multiple bags in a single action using the retractable, pivotable, slidable, and removable horizontal grocery bar. Additionally, when a pair of bag holding systems is used, a cross support bar member is formed to accommodate a variety of hanging items in addition to grocery bags, and may be used to dry clothing or secure netting, for example.

There has thus been outlined, rather broadly, the features of the present invention in order that the detailed description that follows may be better understood, and in order that the present contribution to the art may be better appreciated. There are additionally features of the invention that will be described and which will form the subject matter of the claims. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Additional aspects and advantages of the present invention will be apparent from the following detailed description of an exemplary embodiment which is illustrated in the accompanying drawings.

### BRIEF DESCRIPTION OF THE DRAWINGS

The present invention is illustrated and described herein with reference to the various drawings, in which like reference numbers denote like system components and/or method steps, as appropriate, and in which:

FIG. 1 is a top planar view of a grocery bag holder system according to an embodiment of the present invention, shown fully retracted into its system casing and locked in position while not in use;

FIG. 2 is a top planar view of a grocery bag holder system, illustrating, in particular, the pivoting and rotational movement of the grocery bar, and the various angles at which the grocery bar is locked into position;

FIG. 3 is a top planar view of a grocery bag holder system, illustrating, in particular, the grocery bar extended to a generally ninety degree angle, and the moveability of the linear slide upon the linear track;

FIG. 4 is a top planar view of a grocery bag holder system, illustrating, in particular, the pivoting and rotational movement of the grocery bar, and simultaneously the repositioned linear slide at the opposite end of the linear track;

FIG. 5 is a top planar view of a pair of grocery bag holder systems, illustrating, in particular, how two grocery bag holder systems may be used simultaneously and the resultant cross bar support that is formed by the joining the two grocery bars and where the resultant cross bar is perpendicular to each linear track;

FIG. 6 is a top planar view of a pair of grocery bag holder systems, illustrating, in particular, how two grocery bag holder systems may be used simultaneously and the resultant cross bar support that is formed by the joining the two grocery bars, where the linear slide on left linear track is in the aft position and the linear slide on the right linear track is in the forward position, and where the resultant cross bar is diagonal to each linear track;

FIG. 7 is a top planar view of a pair of grocery bag holder systems, illustrating, in particular, how when two grocery bag holder systems are used simultaneously, the cross support bar formed by the two grocery bars and one handle is detachable and removable for use elsewhere in a vehicle;

FIG. 8 is a front planar view of a detached cross support bar formed by two grocery bars and one handle, detached from a pair of grocery bag holder systems, and shown used as a crossbar to support hanging items;

FIGS. 9 and 10 are front perspective views of a pair of grocery bag holder systems and their relative position to one another as they would be placed in an automobile;

FIG. 11 is a front perspective view of a grocery bag holder system illustrating, in particular, a grocery bar extended from its system casing, a handle, a handle grip, and a raised lip on the handle;

FIG. 12 is a front perspective view of a grocery bag bar illustrating, in particular, a linear slide, a three-position release lever, pivot arm, grocery bar, handle, handle grip, and raised lip on the handle;

FIG. 13 is a front perspective view of a grocery bag holder system illustrating, in particular, a grocery bar stored in its system casing;

FIG. 14 is a front perspective view of a grocery bag holder system illustrating, in particular, the second of a pairing of grocery bag holder systems, wherein there is no handle or handle grip;

FIGS. 15 and 16 are front perspective views of a linear slide according to an embodiment of the present invention, illustrating, in particular the main pivot, three-position release lever, receptacle for the locking screw, and the nylon slide liners;

FIG. 17 is a front planar view of a linear slide according to an embodiment of the present invention, illustrating, in particular the main pivot, three-position release lever, the locking screw, and the nylon slide liners;

FIG. 18 is a front perspective view of a linear slide shown placed on a linear track, illustrating, in particular, the linear track and the linear track grove;

FIG. 19 is a front perspective view of a pivot arm, illustrating, in particular, the receptacle for the main pivot, the pivot arm bar, and a quick release button;

FIG. 20 is a front perspective view of a grocery bar, illustrating, in particular, two quick release buttons;

FIG. 21 is front perspective view of a grocery bar, illustrating, in particular, two quick release buttons and the hole to receive the pivot arm quick release button;

FIGS. 22 and 23 are front perspective views of a handle of the grocery bar holding system according to an embodiment of the present invention, illustrating, in particular, a handle, handle grip, raised lip, and hole to accept the grocery bar quick release button;

FIG. 24 is a front perspective view of a grocery bag holder system, illustrating, in particular, the grocery bar extended to a generally ninety degree angle, and the moveability of the linear slide upon the linear track, and further illustrating how three grocery bags (shown schematically) are placed on and over the grocery bar and handle before the grocery bar has been returned to its stowed location in the system casing;

FIG. 25 is a front planar view of a grocery bag holder system illustrating, in particular, the second of a pairing of grocery bag holder systems, wherein there is no handle or handle grip;

FIG. 26 is a front planar view of a grocery bag holder system illustrating, in particular, linear slide, grocery bar, handle, friction locks, and various quick release buttons;

FIG. 27 is a front perspective view of a pair of grocery bag holder systems and their relative position to one another as placed in an automobile, and further illustrating three grocery bags suspended from the cross support bar created from joining the two grocery bars and secured by the handle; and

FIG. 28 is a front perspective view of a single grocery bag holder system returned to its stowing position in the system casing once three grocery bags were placed upon the grocery bag, and further illustrating the suspension of the grocery bags above the floor in the rear cargo compartment.

### DETAILED DESCRIPTION OF THE INVENTION

Before describing the disclosed embodiments of the present invention in detail, it is to be understood that the invention is not limited in its application to the details of the particular arrangement shown here since the invention is capable of other embodiments. Also, the terminology used herein is for the purpose of description and not of limitation.

The present invention provides a bag holding system 10 for securely holding in place conventional plastic grocery bags 14 when such grocery bags 14, filled with groceries or other items, are being transported in a vehicle, maintaining the bags in an upright, suspended position on or above the floor of the interior trunk or cargo compartment of an automobile.

Referring now to FIG. 1, a grocery bag holder system 10 is shown fully retracted into its system casing 12 and locked in position while not in use. The grocery bag holder system 10 is shown with a grocery bar 60, which pivots out of the system casing 12 located within an interior panel in a cargo area in the automobile, the grocery bar 60 mounted to a pivot arm 30 within the system casing 12. The grocery bar 60, once loaded with the bags, is rotated back on the pivot arm 30 and returned to the system casing 12, thus securely holding the bags in a suspended manner.

The grocery bag holder system 10 includes a linear slide 40, which securely holds the pivot arm 30 and the grocery bar 60 in place, and a linear track 20, upon which the linear slide 40 is mounted and moves in a linear direction. The linear slide 40 and the linear track 20, upon which the linear slide 40 is mounted, are located within the system casing 12.

The pivot arm 30, holding the grocery bar 60, is mounted to the linear slide 40, on the pivot (not shown), the linear slide 40 moving about the linear track 20 in a linear manner. The pivot arm 30 includes a pivot arm bar 34 and a pivot arm quick release button 36 by which the grocery bar 60 is secured to, and easily removed from, the pivot arm 30.

The linear slide 40 includes a release lever 42 and a locking screw (not shown). (The receptacle for the locking screw 44, however, is shown in FIG. 1.) The release lever 42 operates to rotate the locking screw in a downward fashion into a secure position, holding the linear slide 40, pivot arm 30, and grocery bar 60 in place at a chosen location along the linear track 20.

The grocery bag holder system 10 includes a handle 70, located on the grocery bar 60 and which slides along the grocery bar 60; a handle grip 72, located on the handle 70; and a raised lip 74, located on the top outer end of the handle 70, which Prevents bag handles from sliding off of the handle 70. The handle 70 is secured in place along the grocery bar 60 in holes present in the grocery bar 60, and is detached from the holes by use of the quick release button 64 located on the grocery bar 60.

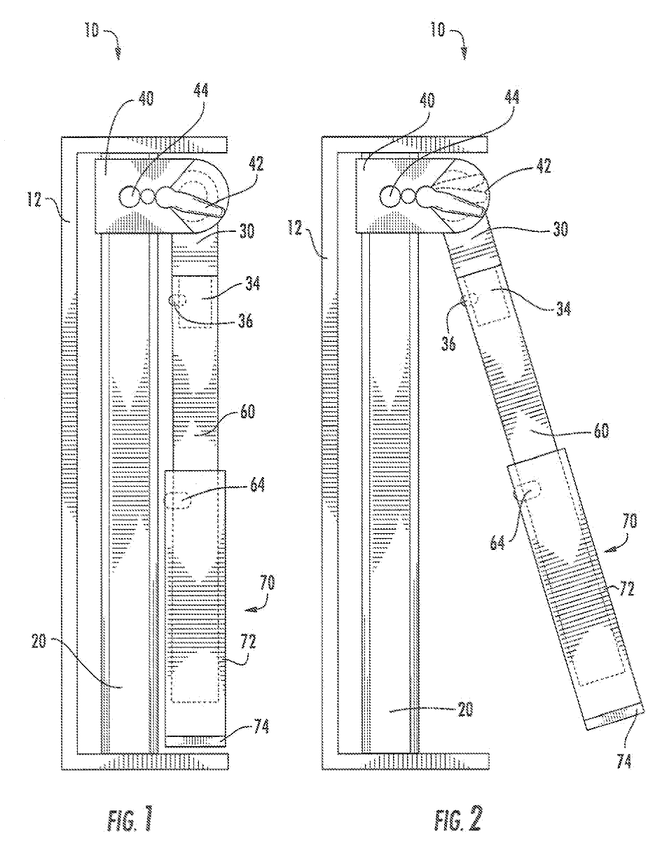

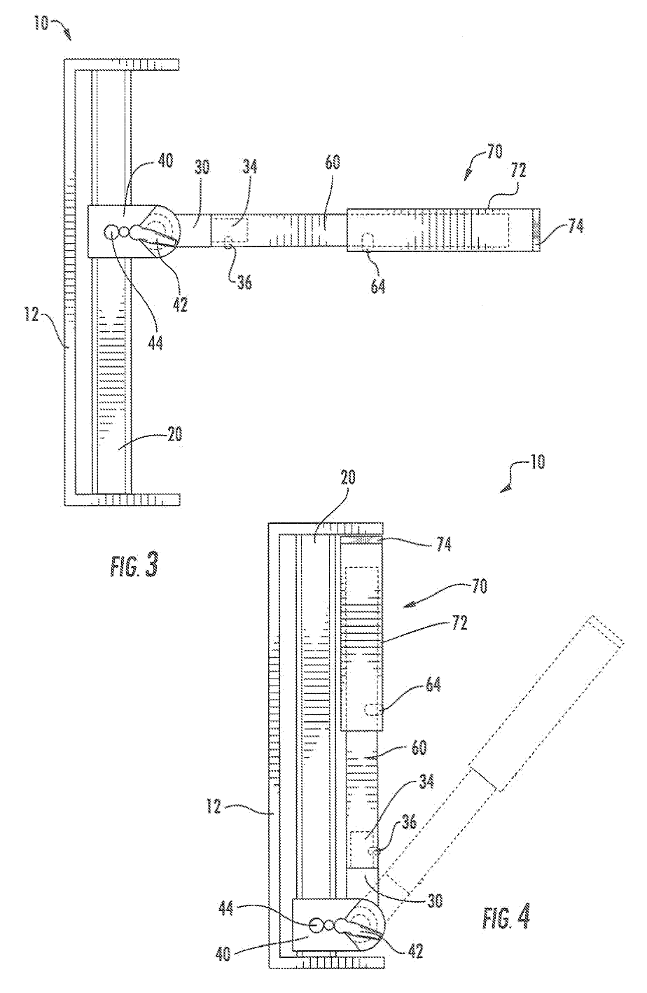

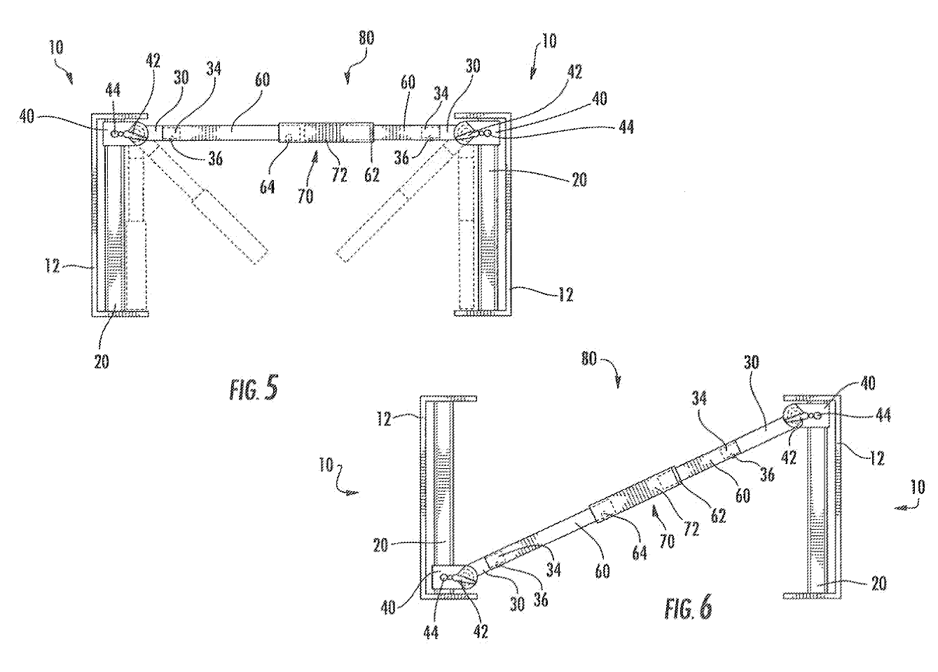

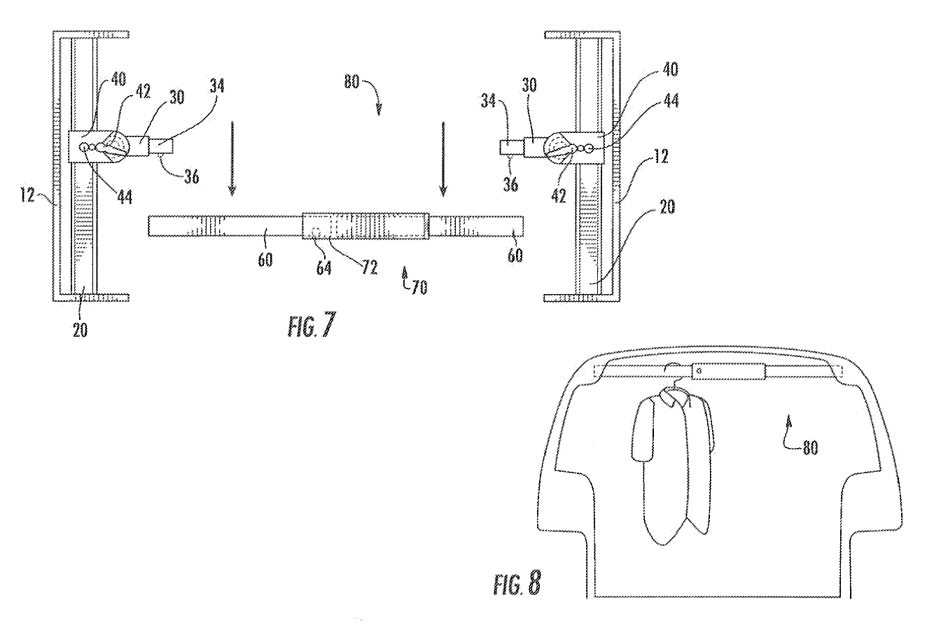

Referring now to FIG. 2, a grocery bag holder system 10 is shown, illustrating the pivoting and rotational movement of the grocery bar 60, and the various angles at which the grocery bar 60 is locked into position. In addition to the references shown in FIG. 1, the release lever 42 shown in FIG. 2 illustrates a three-position release lever 42. The locking screw position is one of one of the three positions on the release lever 42: locked, unlocked, or unlocked-but-spring-loaded to return the release lever to the locked position. As the release lever 42 is unlocked, the grocery bar 60 is gripped by the handle 70 and rotated in an outward direction from the system casing 12. At this point the grocery bar 60 may be locked while extended in an outward position at a desired angle to the linear track 20, or loaded with grocery bags and returned to the original position within the system casing 12 to securely hold grocery bags in a suspended state.

Referring now to FIG. 3, a grocery bag holder system 10 is shown. The grocery bar 60, extended to a generally ninety degree angle, and the moveability of the linear slide 40 upon the linear track 20 is also shown. In this position, the grocery bar 60 is perpendicular to the linear track 20 and the system casing 12. By adjusting the release lever 42, a user may move the linear slide 40 about the linear track 20 and place it at a desired location on the linear track 20.

Referring now to FIG. 4, a grocery bag holder system 10 is shown, illustrating the pivoting and rotational movement of the grocery bar 60, and simultaneously the repositioned linear slide 40 at the opposite end of the linear track 20. The linear slide 40 has been positioned in the aft position of the linear track 20 and system casing 12, relative to the automobile. While in this position, the grocery bar 60 rotates back into the system casing 12 the same as it does when the linear slide 40 is the forward position of the linear track 20 and system casing 12.

Referring now to FIG. 5, a pair of grocery bag holder systems 10, is shown, illustrating how two grocery bag holder systems 10 may be used simultaneously to form a resultant cross bar support 80 by the joining the two grocery bars 60. The resultant cross bar 80 is perpendicular to each linear track 20. One grocery bag holder system 10 is placed on the left, or driver side of the automobile, and a second grocery bag holder system 10 is placed on the right, or passenger side, of the automobile. The grocery bag holder systems 10 are identical with the exception that the one placed on the right, or passenger side does not contain a handle 70. When two systems 10 are used together, the handle 70 in the left, or driver side contains both grocery bars 60. Thus, two grocery bars 60 are secured together and form a cross bar support 80.

Referring now to FIG. 6, a pair of grocery bag holder systems 10, is shown illustrating, in particular, how two grocery bag holder systems 10 may be used simultaneously to form a resultant cross bar support by joining the two grocery bars 60, where the linear slide 40 on left linear track 20 is in the aft position and the linear slide 40 on the right linear track 20 is in the forward position. The resultant cross bar 80 is diagonal to each linear track 20.

Referring now to FIG. 7, a pair of grocery bag holder systems 10 is shown illustrating how when two grocery bag holder systems are used simultaneously the cross support bar 80 formed by the two grocery bars 60 and one handle 70 is detachable and removable for use elsewhere in a vehicle. As the quick release button 36 on each pivot arm 30 is depressed the cross support bar 80, formed by the combination of two grocery bars 60 and one handle 70, is detachable from the two grocery bag holder systems 10. The detached cross support bar 80 is available for use elsewhere in the automobile. The cross support bar 80 provides versatile functionality in both detached and attached modes. In one alternative embodiment, for example, the cross support bar 80, without being detached, provides load support for flip up load floors from the second row seat (not shown). In another alternative embodiment, for example, the cross support bar 80 also provides integration with a tonneau cover (not shown). In yet another alternative embodiment, for example, the cross support bar 80 provides support for flip up shelves that are hinged on the back of the second row eat (not shown). Thus, the cross support bar 80 is useful in both detached and attached modes to provide support for various items. These alternative embodiments of the cross support bar 80 are not intended to be limiting but rather are disclosed to show the versatility and functionality of the cross support bar 80.

Referring now to FIG. 8, a detached cross support bar 80 formed by two grocery bars 60 and one handle 70, detached from a pair of grocery bag holder systems 10 is shown. The cross support bar 80 shown here is used suspended from an elevated interior position in the automobile and used to support hanging clothing items.

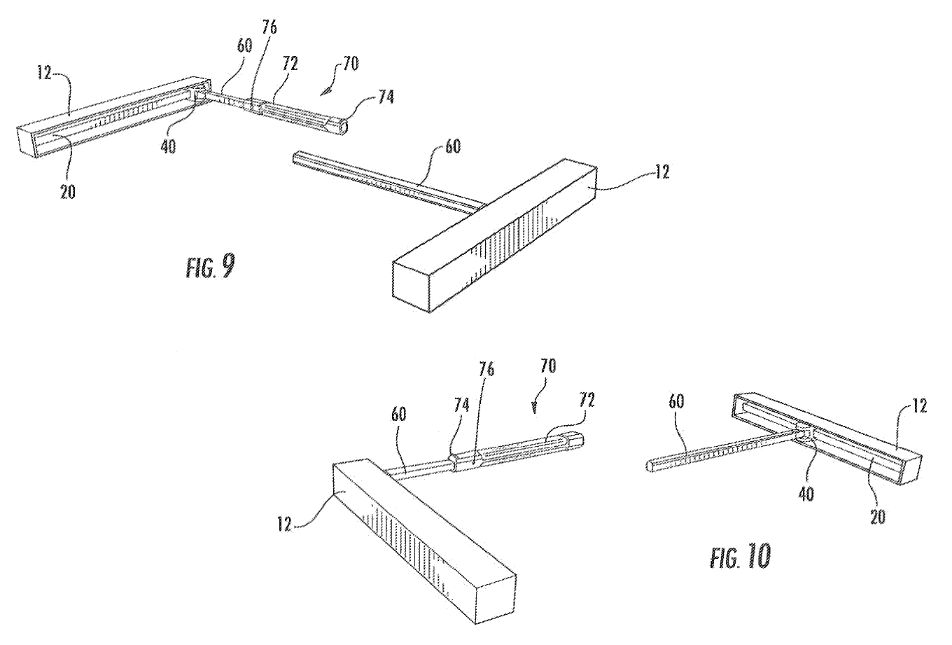

Referring now to FIGS. 9 and 10, a pair of grocery bag holder systems 10 and their relative position to one another as they would be placed in an automobile are shown. One grocery bag holder system 10 is placed on the left, or driver side of the automobile, and a second grocery bag holder system 10 is placed on the right, or passenger side, of the automobile. The grocery bag holder systems 10 are identical with the exception that the one placed on the right, or passenger side does not contain a handle 70. The grocery bars 60 are shown extended to a generally ninety degree angle to the linear track 20.

Referring now to FIG. 11, a grocery bag holder system 10 illustrating a grocery bar 60 extended from its system casing 12 is shown. The grocery bar 60 is extended to a generally ninety degree angle. In this position, the grocery bar 60 is perpendicular to the linear track 20 and the system casing 12. By adjusting the release lever 42, a user may move the linear slide 40 about the linear track 20. The grocery bar is shown equipped with a handle 70, handle grip 72, and raised lip 74 on the handle 70.

Referring now to FIG. 12, a grocery bar 60 is shown. The grocery bar 60 is mounted to the linear slide 40 and is locked into position using the three-position release lever 42. The grocery bar 60 is equipped with a handle 70, handle grip 72, and raised lip 74 on the handle 70.

Referring now to FIG. 13, a grocery bag holder system 10 is shown. The grocery bar 60 is stored and locked into position within the system casing 12 and secured into place with the three-position release lever 42.

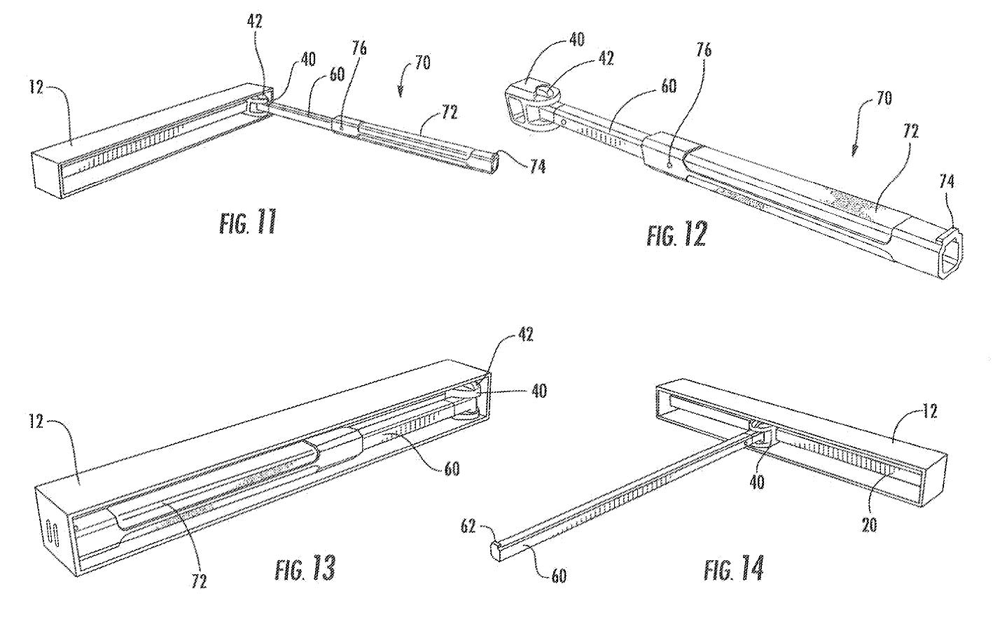

Referring now to FIG. 14, a grocery bag holder system 10 is shown illustrating, the second of a pairing of grocery bag holder systems 10, wherein there is no handle or handle grip. The grocery bar 60 includes a raised lip 62, located on the top outer end of the grocery bar 60, which prevents bag handles from sliding off of the grocery bar 60. The grocery bar 60 and linear slide 40 are shown approximately at the midpoint on the linear track 20, illustrating the moveability of the linear slide 40 upon the linear track 20 and the various locations upon the linear track 20 where the grocery bar 60 is placed.

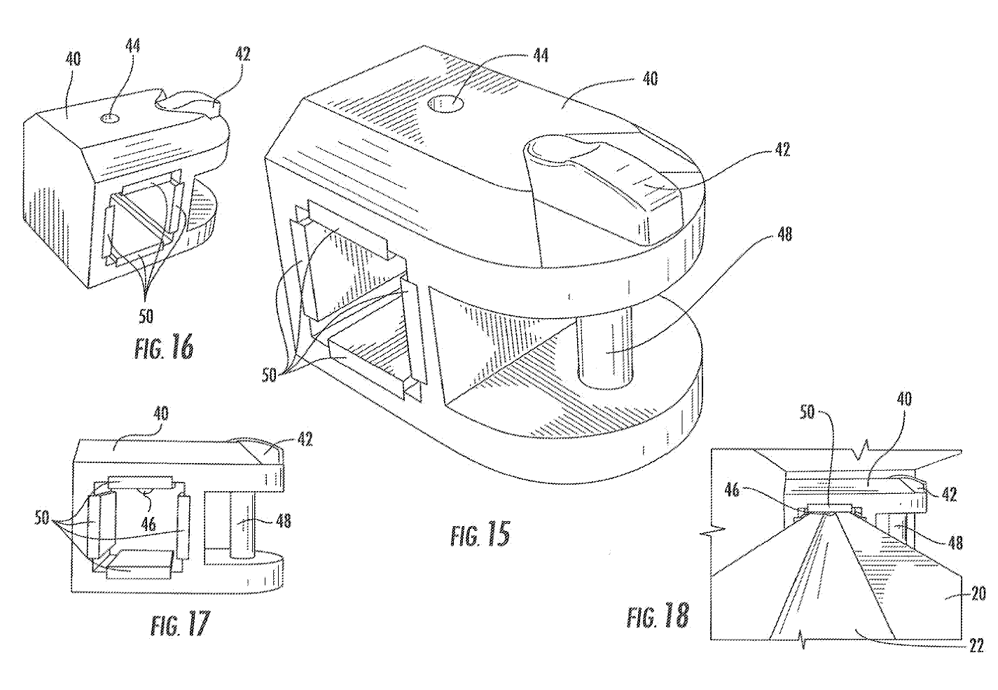

Referring now to FIGS. 15, 16, and 17, various views of a linear slide 40 are shown. The linear slide 40 is shown with the main pivot 48, three-position release lever 42, receptacle for the locking screw 44, and the nylon slide liners 50. The slide liners 50 act as a cushion between the linear slide 40 and the linear track 20 and allow for a smooth motion about the linear track 20.

Referring now to FIG. 18, a linear slide 40 is shown. The linear slide 40 is placed on a linear track 20, illustrating the linear track 20 and the linear track grove 22. The linear slide 40 includes a release lever 42 and a locking screw 46. The linear track 20 includes a linear groove 22. The three-position release lever 42 operates to rotate the locking screw 46 in a downward fashion into a secure position, holding the linear slide 40, pivot arm (not shown), and horizontal bar (not shown) in place at a location along the linear track 20. The locking screw 46 is accepted by the linear groove 22 in the linear track 22.

Referring now to FIG. 19, a pivot arm 30 is shown. The pivot arm 30 is illustrated with the receptacle for the main pivot 32, the pivot arm bar 34, and a quick release button 36. The pivot arm 30 is mounted on the main pivot 48 of the linear slide 40 (not shown).

Referring now to FIGS. 20 and 21, views of a grocery bar 60 are shown. The grocery bar 60 is illustrated with two quick release buttons 65. The quick release buttons 64 are used in conjunction with the sliding handle 70 (not shown) to hold the handle in place at a predetermined location. Release of the handle 70 is accomplished by depressing the two quick release buttons 64 and then sliding the handle 70. FIG. 21 also illustrates the hole 66 in the grocery bar 60 to accept the quick release button of the pivot arm (not shown).

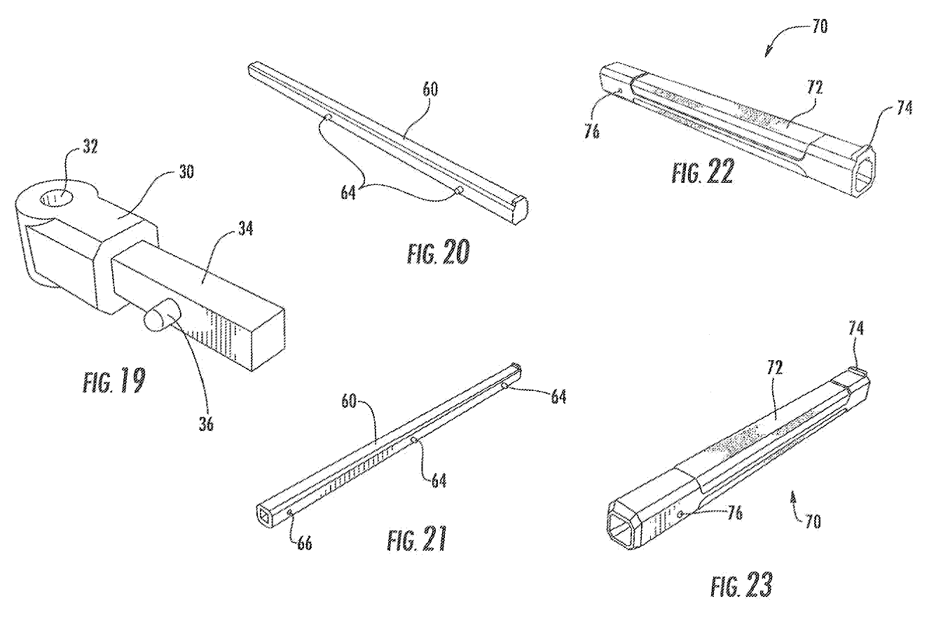

Referring now to FIGS. 22 and 23, views of a handle 70 of the grocery bar holding system 10 are shown. The handle 70 is illustrated with a handle grip 72, raised lip 74, and a hole 76 to accept the grocery bar quick release button.

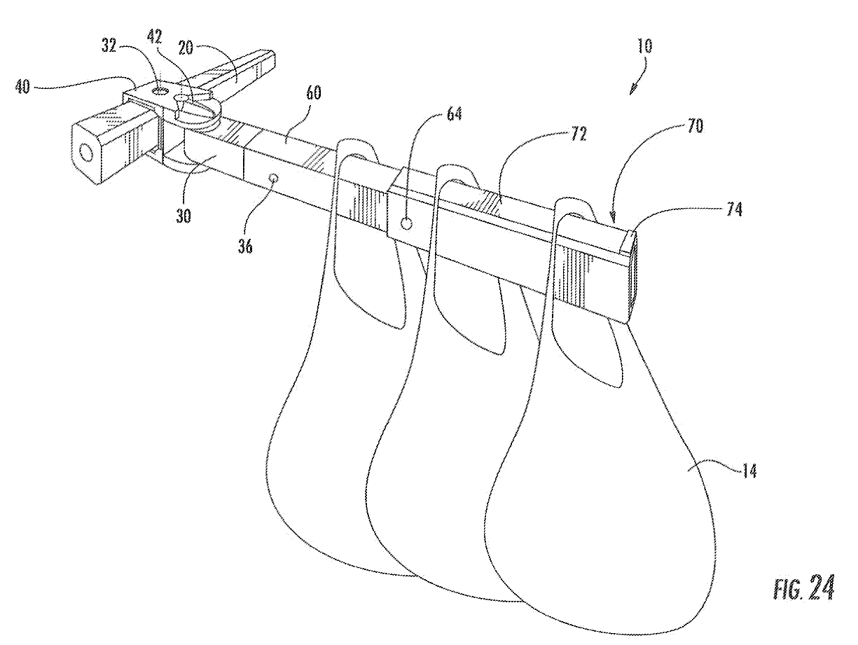

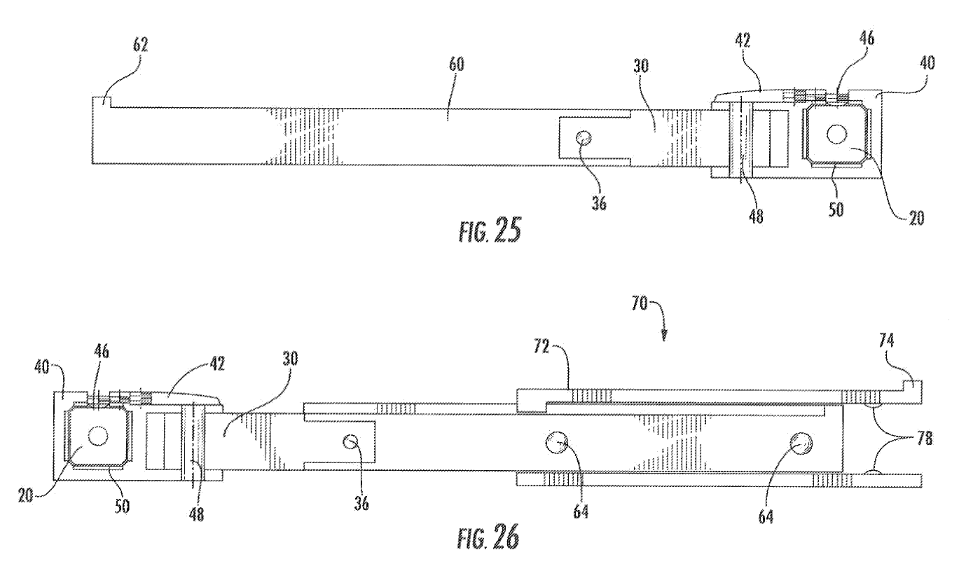

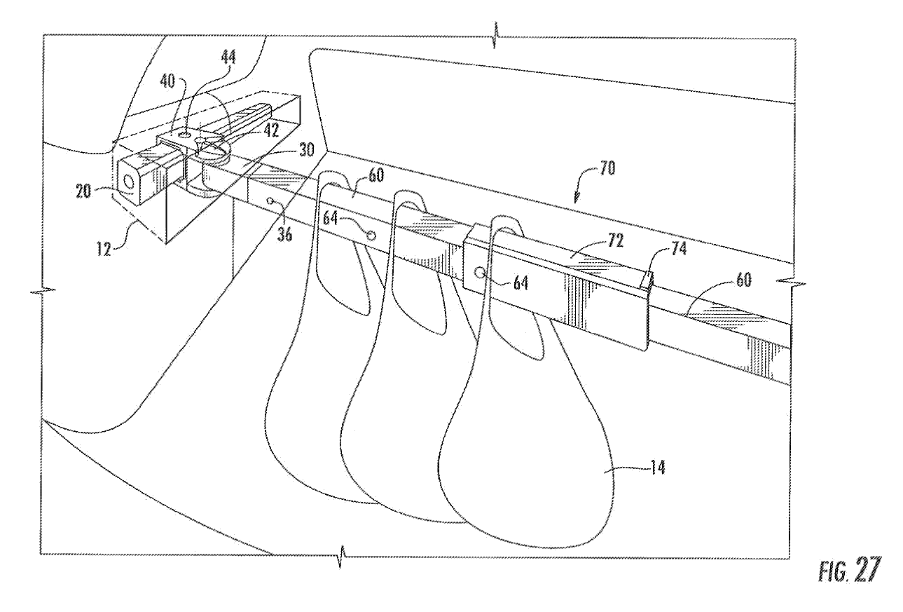

Referring now to FIG. 24, a grocery bag holder system is shown in use with grocery bags 14, shown schematically. The grocery bar 60 is extended to a generally ninety degree angle, illustrating how three grocery bags 14 are placed on and over the grocery bar 60 and handle 70 before the grocery bar 60 has been returned to its stowed location in the system casing 12 (not shown). The raised lip 74 on the handle acts to prevent the grocery bags 14 from sliding off of the grocery bar 60.

Referring now to FIG. 25, a grocery bar 60 and linear slide 40 is shown. The grocery bar 60 shown in this figure is illustrative of a grocery bar 60 used on the right, or passenger side of an automobile, wherein there is no handle or handle grip on the grocery bar 60. The grocery bar 60 includes a raised lip 62, located on the top outer end of the grocery bar 60, which prevents bag handles from sliding off of the grocery bar 60. The linear slide 40 is placed on a linear track 20. The linear slide 40 includes a release lever 42 and a locking screw 46. The linear track 20 includes a linear groove 22. The three-position release lever 42 operates to rotate the locking screw 46 in a downward fashion into a secure position, holding the linear slide 40, pivot arm 30, main pivot 48, and grocery bar 60 in place at a location along the linear track 20. The grocery bar 60 is detachable from the pivot arm 30 by depressing the quick release button 36.

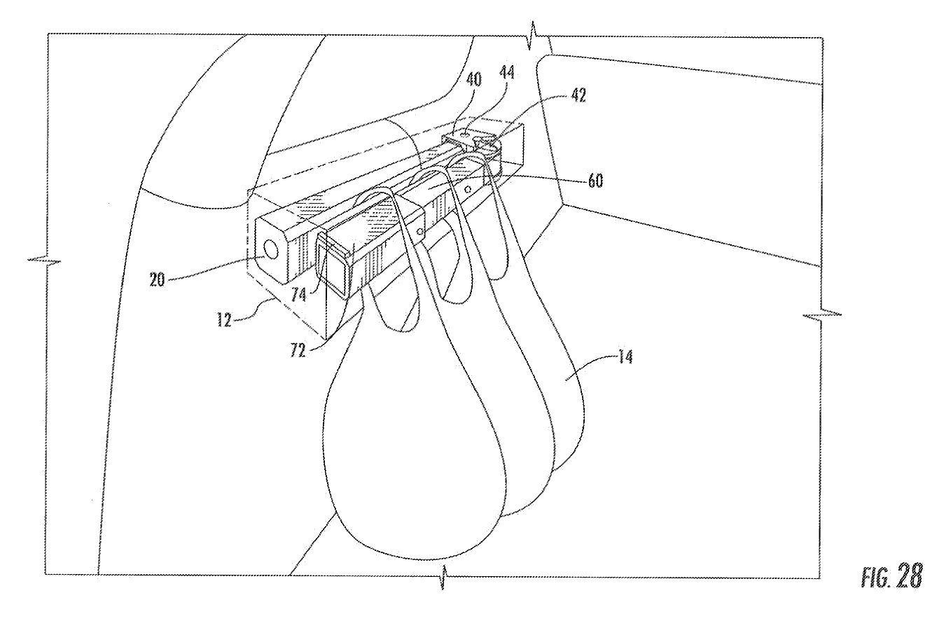

Referring now to FIG. 26, a grocery bar 60 is shown. The grocery bar 60 shown in this figure is illustrative of a grocery bar 60 used on the left, or driver side of an automobile. In addition to the grocery bar features shown in FIG. 25, this grocery bar 60 is illustrated with the a handle 70, friction locks 78, and quick release buttons 64 to remove the handle from the grocery bar 60.

Referring now to FIG. 27, a pair of grocery bag holder systems and their relative position to one another as placed in an automobile is shown. Three grocery bags 14 are shown suspended from the cross support bar created by joining the two grocery bars 60 and secured by the handle 70.

Referring now to FIG. 28, a single grocery bag holder system 10 returned to its stowing position in the system casing 12 once three grocery bags 14 were placed upon the grocery bar 60 is shown. The grocery bags 14 are shown suspended above the floor in the rear cargo compartment.

The grocery bag holder system 10 is made from a variety of manufacturing materials well-known in the automotive industry. A key factor used in choosing manufacturing materials is the resultant strength of the grocery bar 60 and related components, such that the system 10 can maintain repeated use by a consumer, and support various weights. Manufacturing materials include, for example, steel, plastic, and nylon composite.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A bag holding system for securely holding in place filled bags equipped with handles in an upright, suspended position while being transported in an automobile, the bag holding system comprising:
a system casing comprising a pivot arm;
a horizontal bar member connected to the pivot arm and selectively disposed within the system casing and selectively pivoting out of the system casing; and
wherein the horizontal bar, once loaded with the bags, is rotated back on the pivot arm and returned to the system casing, thus securely holding the bags in a suspended manner.

2. The bag holding system of claim 1, further comprising:
a raised lip, located on the top outer end of the horizontal bar, which prevents bag handles from sliding off of the horizontal bar.

3. The bag holding system of claim 1, further comprising:
a linear slide, comprising a pivot, which securely holds the pivot arm and the horizontal bar, and a plurality of slide liners;
a linear track, upon which the linear slide is mounted and moves in a linear direction, wherein the slide liners act as a cushion between the linear slide and the linear track and allow for a smooth motion about the linear track;
wherein the linear slide and the linear track, upon which the linear slide is mounted, are located within the system casing; and
wherein the pivot arm holding the horizontal bar, the pivot arm having a receptacle for the pivot, is mounted to the linear slide, on the pivot, the linear slide moving about the linear track in a linear manner.

4. The bag holding system of claim 1:
wherein the linear slide is further comprised of a release lever and a locking screw;
wherein the linear track is further comprised of a linear groove;
wherein the release lever operates to rotate the locking screw in a downward fashion into a secure position, holding the linear slide, pivot arm, and horizontal bar in place at a location along the linear track; and
wherein the locking screw is accepted by the linear groove in the linear track.

5. The bag holding system of claim 4:
wherein the release lever is a three-position release lever; and
wherein the locking screw position is one of one of locked, unlocked, or unlocked-but-spring-loaded to return the release lever to the locked position.

6. The bag holding system of claim 1, wherein the pivot arm is further comprised of a quick release button such that the horizontal bar is detachable and removable from the pivot arm.

7. The bag holding system of claim 1, further comprising:
a handle, located on the horizontal bar and which slides along the horizontal bar;
a handle grip, located on the handle;
a raised lip, located on the top outer end of the handle, which prevents bag handles from sliding off of the handle; and
a receptacle to a quick release button on the horizontal bar, wherein the quick release button, when located in the handle receptacle, acts to hold the handle in a predetermined location along the horizontal bar.

8. The bag holding system of claim 1, further comprising:
a second horizontal bar, which pivots out of a second system casing located within an interior panel in a cargo area in the automobile, the second horizontal bar mounted to a second pivot arm within the second system casing, wherein the second horizontal bar is mounted in an opposite interior panel in the cargo area in the automobile.

9. The bag holding system of claim 8:
wherein the horizontal bar and second horizontal bar are joined together with a handle located on the horizontal bar and securely attached one to another, thus providing a cross support bar.

10. The bag holding system of claim 9, wherein the handle located on the horizontal bar is further comprised of a pair of friction locks, located on the top and bottom interior sides of the handle, the friction locks securely holding the second horizontal bar in place when the horizontal bar and second horizontal bar are joined together to create the cross support bar.

11. The bag holding system of claim 10, wherein the cross support bar, formed when then the horizontal bar and second horizontal bar are joined together, is detachable and removable for use independent from the bag holding system, wherein the horizontal bar and the second horizontal bar are detached from their respective pivot arms by depressing the quick release button the horizontal bar and the second horizontal bar.
